(19) United States
(12) Patent Application Publication
(10) Pub. No.: US 2008/0291673 A1
(43) Pub. Date: Nov. 27, 2008

(54) Illumination device

(75) Inventors: Hon-Lun Chen, Taipei Hsien (TW); Kuo-Hsin Teng, Taipei Hsien (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/907,364

(22) Filed: Oct. 11, 2007

(30) Foreign Application Priority Data
May 22, 2007 (TW) 096118153

(51) Int. Cl. H05B 41/36; F21V 9/00

(52) U.S. Cl. 362/231; 315/294

(57) ABSTRACT

An illumination device includes an illumination unit and a control unit. The illumination unit has a plurality of light-emitting diodes (LEDs). The LEDs are disposed adjacent to each other and emit different colors of light. The control unit is electrically connected with the LEDs to control the LEDs, respectively.

### CROSS REFERENCE TO RELATED APPLICATIONS

This Non-provisional application claims priority under 35 U.S.C. §119(a) on Patent Application No(s). 096118153 filed in Taiwan, Republic of China on May 22, 2007, the entire contents of which are hereby incorporated by reference.

### BACKGROUND OF THE INVENTION

1. Field of Invention

The invention relates to an illumination device and, in particular, to an illumination device having light-emitting diodes (LEDs).

2. Related Art

Illustration devices are indispensable in many articles for daily use. In particular, illumination devices such as incandescent lamps, desktop lamps, hanging lamps, wall lamps, or neon lights have become very popular. They can not only brighten the dark but also blossom people's lives.

FIG. 1 shows the structure of a conventional desktop lamp 1, which has a base 11, support unit 12 and an illumination unit 13. The support unit 12 is disposed on the base 11, and the illumination unit 13 is fixed on the support unit 12. The illumination unit 13 has a lamp 131 and a lampshade 132. The lamp 131 can emit light for illustration, and the lampshade 132 covers and protects the lamp 131. Moreover, the lampshade 132 makes the light emitted from the lamp 131 downward. The base 11 has a switch 111 and a knob 112. The switch 111 is electrically connected to an external power line 14 for turning on or turning off the lamp 131. In addition, a power line 121 is disposed in the support unit 12 for electrically connecting the knob 112 and the lamp 131 of the illumination unit 13. Thus, by controlling the current applied to the power line 121, the brightness of the light emitted from the lamp 131 can be controlled.

However, simply using the knob 112 to control the brightness of the desktop lamp 1 can not satisfy the modern customers. In addition, the conventional illumination device usually has the light source of a single color, so that the customers do not have further choices for the light source. Therefore, it is an important subject of the invention to provide an illumination device that can provide the control of its lighting intensities of different color lights.

### SUMMARY OF THE INVENTION

In view of the foregoing, the invention is to provide an illumination device that can provide the control of its lighting intensities of different color lights.

To achieve the above, the invention discloses an illumination device including an illumination unit and a control unit. The illumination unit has a plurality of light-emitting diodes (LEDs) emitting different colors of light and disposed adjacent to each other. The control unit is electrically connected with the LEDs for controlling the LEDs.

As mentioned above, the illumination device of the invention has the control unit for controlling the LEDs to emit light of different colors. Compared with the related art, the LED has the advantages of low power consumption, long lifetime, good color saturation, high light-emitting efficiency, and adjustable color temperature. In addition to being free from frequent replacements, the LED also provides stable light, increases its usage rate, saves energy, and reduces the cost. Besides, the invention uses a control unit to control the LEDs emitting light of different colors, so that the user can control the desired brightness and color. Accordingly, the illumination device of the invention has good practicability and attracts the user's attention.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic view showing the structure of a conventional illumination device;

FIG. 2 is a schematic view showing the structure of an illumination device according to a preferred embodiment of the invention;

FIGS. 3A to 3C are schematic views showing different aspects of the control unit shown in FIG. 2; and

FIGS. 4A to 4C are schematic views showing the operations of the control unit shown in FIG. 3A

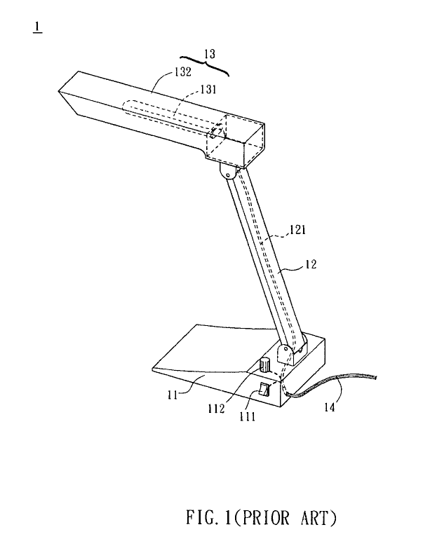

### DETAILED DESCRIPTION OF THE INVENTION

The present invention will be apparent from the following detailed description, which proceeds with reference to the accompanying drawings, wherein the same references relate to the same elements.

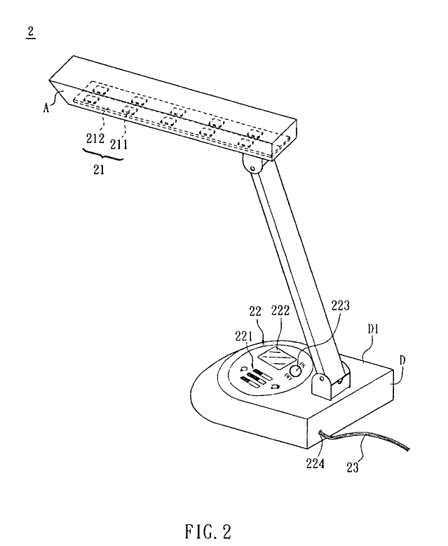

FIG. 2 shows the structure of an illumination device 2 according to a preferred embodiment of the invention. The illumination device 2 can be a desktop lamp, a wall lamp, a hanging lamp, an incandescent lamp or a neon light. In the present embodiment, the illumination device 2 is, for example, a desktop lamp. The illumination device 2 includes an illumination unit 21 and a control unit 22 that are electrically connected with each other. In this embodiment, the illumination unit 21 is disposed inside a lampshade A, which is disposed over a base D. The control unit 22 is disposed on a surface D1 of the base D.

The illumination unit 21 provides the light for illumination. In the embodiment, the illumination unit 21 has several light emitting diodes (LEDs) 211 disposed on a circuit board 212. The LEDs 211 include at least one red LED, at least one green LED, at least one blue LED, at least one yellow LED or at least one white-light LED. Of course, the LEDs 211 can be any color or a mixture of several colors according to the user's need. The LEDs 211 are disposed adjacent to each other, and emit light of different colors that are mixed in different proportions to provide desired color light. Therefore, in addition to white light, light of different colors can be produced to achieve certain effects.

The control unit 22 has a brightness control area 221, a display area 222 and a switch 223. The bright control area 221 is electrically connected with the circuit board 212 of the illumination unit 21 for adjusting the brightness or lighting intensity of each LED 211, such as the green, blue, yellow or white-light LED. The control unit 22 can have different shape embodiments that are described below.

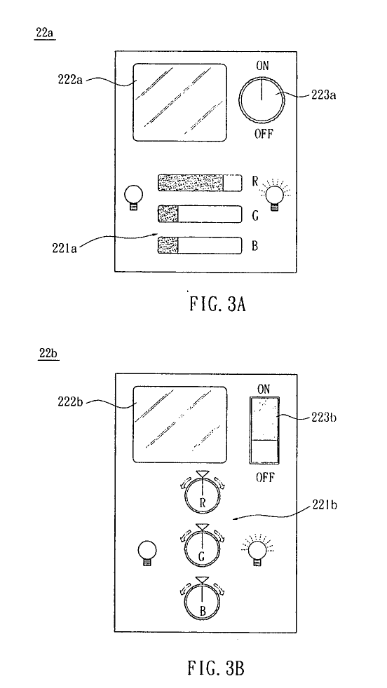

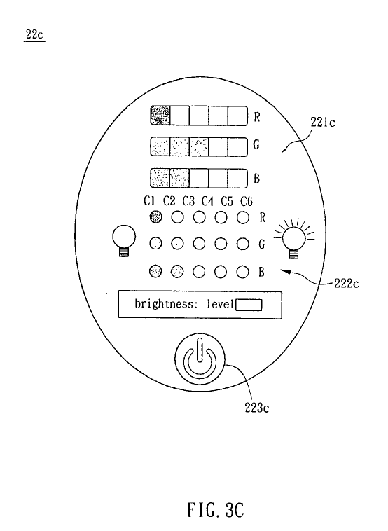

FIGS. 3A to 3C are schematic views of different aspects of the control unit 22 in FIG. 2. As shown in FIGS. 3A and 3C, the brightness control area 221a/221c of the control unit 22a/22c is a touch-control panel. As shown in FIG. 3B, the brightness control area 221b of the control unit 22b is a knob. In FIGS. 3A and 3C, when the brightness control area 221a/221c is a touch-control panel, the user can use his/her finger or a touch-control pen to touch the brightness control area 221a/221c, thereby controlling the brightness and spectrum of the LEDs 211 in the illumination unit 21. In FIG. 3B, when the brightness control area 221c is a knob, the user can turn it to adjust the brightness, spectrum and color temperature of the LEDs 211 in the illumination unit 21.

The shape of the brightness control area 221 is not restricted by the invention. It can have a stripe shape (as shown in FIGS. 3A and 3C), a saw shape (not shown), a spiral shape (not shown), a circular shape (not shown), a W shape (not shown), a Z shape (not shown), an e shape (not shown), or some irregular shapes.

In FIG. 3A, the brightness control area 221a can have different brightness control ranges according to the LEDs 211 of different colors in the illumination unit 21. For example, the illumination unit 21 may include three LEDs 211, which respectively emit light of wavelengths 430 nm, 555 nm, and 630 nm (Red, Green and Blue). If the illumination device 2 is used as a desktop lamp, the red, green and blue light emitted by the LEDs 211 can be mixed to form a white light, yellow light or any preferred color light depending on the applied current. If the illumination device 2 is used as the neon light of specific color, the lighting intensities of, for example, the red or green light can be increased to form the slight-red light or slight-green light. Alternatively, as shown in FIG. 3B, the brightness control area 221b can have a knob for controlling the brightness of the LEDs 211 of each color or the mixture brightness of all the LEDs 211.

To be noted, in addition to adjusting brightness, the control unit 22 can further adjust the color temperature of the LEDs 211 of different colors using a control circuit (not shown) that is in electrical connection with the circuit board 212 of the illumination unit 21. For example, the illumination unit 21 has LED series of red, green and blue colors (not shown). The LED series are connected in parallel via a resistor (not shown). The user can adjust the magnitudes of electrical currents flowing through the LED series by changing the resistance of the resistors.

For example, if a larger electrical current flows through the red LED series, then the brightness and color temperature of red color produced thereby is larger. On the other hand, if the electrically current flowing through the red LED series is smaller, the brightness and color temperature produced by the red LED series is lower. Therefore, the user can use the above method or other conventional circuit control method to control the LEDs or LED series of different colors in the illumination unit 21 for rendering different brightness and color temperature. This produces different effects in order to suit seasonal changes or personal tastes.

As shown in FIG. 3C, the brightness control area 221c is divided into several sections, each of which represents a distinct brightness level. Of course, the number of sections can be adjusted according to practical needs. This allows the user to readily determine the required brightness using the sections shown in the brightness control area 221c. The brightness can be touch-controlled as well.

For example, as showing in FIG. 3C, when the user wants to change the brightness from level 1 to level 3, he or she can touch the first section C1 in the brightness control area 221c and move to the third section C3, according to the definition of a circuit board (not sown) of the control unit 22c. In the embodiment, the brightness increases along the direction from the first section C1 to the sixth section C6. Alternatively, the user can touch any section in the brightness control area 221c and move a distance of two sections in the brightness control area 221b. This also changes the brightness of the illumination unit 21 from the original level 1 to level 3. Of course, the user can also directly touch the third section C3 in the brightness control area 221c to change the brightness of the green light source to the level 3. In practice, the user has several ways to change the brightness of the illumination unit 21 using the brightness control area 221c. Any other way of changing the brightness of the illumination unit 21 using the touch-control method should be construed as part of the invention.

Please refer to FIG. 2 again. The display area 222 is electrically connected with the illumination unit 21 for displaying the brightness level thereof. In particular, the display area 222 can be a liquid crystal display (LCD) panel (222a in FIG. 3A and 222b in FIG. 3B), several light sources (not shown), or the combination of a display panel and LEDs (222c in FIG. 3C). When the display area 222 receives a change in the brightness of the illumination unit 21, as shown in FIGS. 3A or 3B, the brightness level of the illumination unit 21 is shown on the LCD panel. Alternatively, as shown in FIG. 3C, such brightness level can be represented by the number of LEDs that are turned on. Moreover, the display panel and the LEDs can be simultaneously used to show the brightness level of the illumination unit 21.

When the display area 222 is a display panel 222a as shown in FIG. 3A, the brightness level can be indicated by the color brightness. Alternatively, as shown in FIG. 3C, the brightness level can be indicated by numbers (as shown in FIG. 3C). Of course, the display panel can use both methods at the same time. In other words, any method that uses the display panel to show the brightness level of the illumination unit 21 should be construed as part of the invention.

With reference to FIG. 2, the switch 223 is electrically connected with a power input terminal 224 of the control unit 22 in order to electrically connect with an external power line 23. This controls the on and off of the illumination device 2. The switch 223 can be a knob switch (223a in FIG. 3A), a touch-control switch (223b in FIG. 3B), or a button switch (223c in FIG. 3C). Besides, the switch 223 can be disposed at any position.

The control unit 22 may further have a situation touch-control area (not shown). According to the type of the illumination unit 21, the situation touch-control area has several touch-control buttons (not shown) for different situations. For example, if the illumination unit 21 consists of several red, blue and green LEDs, then the situation touch-control area has an illumination situation button, a read situation button, a sleep situation button and a candle situation button. They use predetermined parameter values to mix light of different colors and brightness, so that the user can press any of the situation buttons to quickly obtain desired brightness and color light.

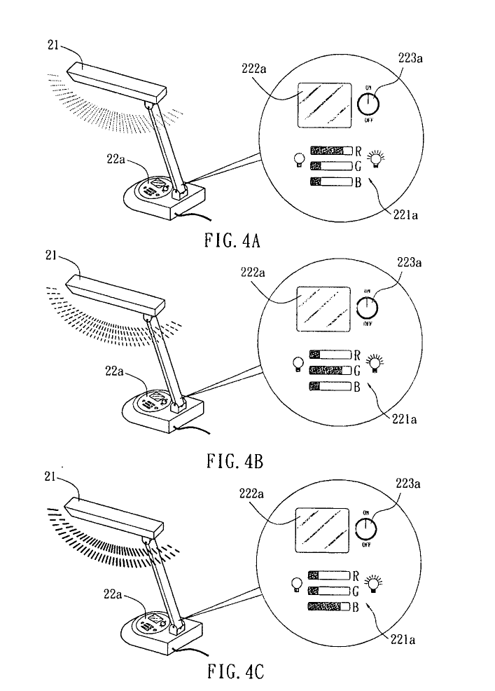

With reference to FIGS. 4A to 4C, to make the above-mentioned embodiment more comprehensive, the operation of the control unit 22a shown in FIG. 3A will be described hereinafter. In this embodiment, the illumination unit 21 includes a plurality of red LEDs, green LEDs and blue LEDs (not shown), and the LEDs are disposed adjacent to each other.

First, the user turns the switch 223a of the control unit 22a so as to enable the illumination device 2.

Then, as shown in FIG. 4A, when the user needs red or slight-red light, he/she can touch the stripe R, which represents red light, in the brightness control area 221a, and slide toward the direction of increasing brightness. Accordingly, the brightness of the red LEDs increases as more area in the stripe R is slid.

As shown in FIG. 4B, if the user thinks that the brightness of the green LED is lower and that of the red LED is higher, he/she can touch the stripe G, which represents green light, in the brightness control area 221a, and slide toward the direction of increasing brightness. Then, he/she can further touch the stripe R and slide toward the direction of decreasing brightness. Accordingly, the brightness of the green LEDs increases as more area in the stripe G is slid, and the brightness of the red LEDs decreases as more area in the stripe R is slid.

As shown in FIG. 4C, if the user thinks that the brightness of the blue LED is lower and that of the green LED is higher, he/she can touch the stripe B, which represents blue light, in the brightness control area 221a, and slide toward the direction of increasing brightness. Then, he/she can further touch the stripe G and slide toward the direction of decreasing brightness. Accordingly, the brightness of the blue LEDs increases as more area in the stripe B is slid, and the brightness of the green LEDs decreases as more area in the stripe G is slid.

In the above operations, the brightness of the illumination device 2 can be controlled by the actions of touching the stripes R, G or B in brightness control area 221a and sliding toward desired directions.

In summary, the illumination device of the invention has the control unit for controlling the LEDs to emit light of different colors. Compared with the related art, the LED has the advantages of low power consumption, long lifetime, good color saturation, high light-emitting efficiency, and adjustable color temperature. In addition to being free from frequent replacements, the LED also provides stable light, increases its usage rate, saves energy, and reduces the cost. Besides, the invention uses a control unit to control the LEDs emitting light of different colors, so that the user can control the desired brightness and color. Accordingly, the illumination device of the invention has good practicability and attracts the user's attention.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An illumination device, comprising:
an illumination unit, which has a plurality of light-emitting diodes (LEDs) emitting different colors of light and disposed adjacent to each other; and
a control unit, which is electrically connected with the LEDs for controlling the LEDs.

2. The illumination device of claim 1, wherein the control unit has a brightness control area, and the brightness control area is a touch-control panel or a knob.

3. The illumination device of claim 2, wherein the brightness control area has a stripe shape, a circular shape, a saw shape, a spiral shape, a W shape, a Z shape, or an irregular shape.

4. The illumination device of claim 1, wherein the control unit has a display area showing a brightness of the illumination unit.

5. The illumination device of claim 1, wherein the control unit has a switch and the switch is a touch-control switch, a button switch, or a knob switch.

6. The illumination device of claim 1, further comprising:
a base; and
a lampshade, which is disposed over the base, wherein the control unit is disposed on one surface of the base, and the illumination unit is disposed in the lampshade.

7. The illumination device of claim 1, wherein the LEDs at least includes a red LED, a greed LED or a blue LED.

8. The illumination device of claim 1, wherein the illumination unit further comprises a circuit board, and the LEDs are disposed on the circuit board.

9. The illumination device of claim 1, wherein the control unit has a control circuit for controlling a brightness or a color temperature of each of the LEDs.
